(19) United States
(12) Patent Application Publication
(10) Pub. No.: US 2026/0235943 A1
(43) Pub. Date: Aug. 13, 2026

(54) 3D-ENABLED HIGH-BRIGHTNESS METAL SCREEN DEVICE

(71) Applicant: Sug Bae KIM, Daegu (KR)

(72) Inventor: Sug Bae KIM, Daegu (KR)

(21) Appl. No.: 19/153,757

(22) PCT Filed: Jan. 23, 2024
(86) PCT No.: PCT/KR2024/001066

§ 371 Date: Aug. 5, 2025

(30) Foreign Application Priority Data
Feb. 6, 2023 (KR) 10-2023-0015488

(51) Int. Cl. G03B 21/58; G03B 21/60; G09G 3/00

(52) U.S. Cl. CPC G03B 21/58; G03B 21/60; G09G 3/03; G09G 2320/0242; G09G 2320/0626; G09G 2320/068; G09G 2330/023; G09G 2358/00

(57) ABSTRACT

The present invention relates to a 3D-enabled high-brightness metal screen device for a projector, and to a 3D high-brightness metal screen device having optical characteristics of scattering and reflecting, at a set angle and only toward a front viewable area, image light incident from a projector, the device comprising: a reflective panel portion, which is formed in a panel shape from a metallic material with the optical characteristic of a scattering and reflecting function, has a front surface formed as a spherical surface recessed rearward, and has a rear surface formed as a spherical surface protruding rearward; and a plurality of metal crystal protruding/recessed portions which protrude at the front surface of the reflective panel portion so as to have a set surface roughness (Ra), and which scatter and reflect, at a set angle and toward the viewable area having been set, the light emitted from the projector.

### TECHNICAL FIELD

The present invention relates to a 3D-enabled high-brightness metal screen device, and more particularly, to a 3D-enabled high-brightness metal screen device capable of focusing light of an image irradiated from a projector onto a viewable section.

### BACKGROUND ART

In general, a projector is installed therein with a screen for projecting an image to view the projected image, and has a structure in which the image projected from the projector is scattered and reflected by the screen and transmitted to a viewer.

The above projector screen is required to have a material, reflectivity and the like appropriately adjusted to display the image projected from the projector more clearly and brightly, and the image projected from the projector is diffusely reflected by the screen and spread over a wide area toward the viewer, thereby allowing the viewer to view the image from various angles.

However, since the projector is configured to be installed at an R position of two divisions and light of the image is reflected in parallel, the conventional projector screen fails to define viewing angles in the left and right directions, thereby causing a narrow viewable section, and accordingly, it has a complex structure because multiple projectors are required, and has a structure such that viewing is available remotely only because the viewing is not possible from a close distance.

Documents in the art related to the present invention include Korean Patent Publication No. 10-2003-0017088 (Mar. 3, 2003), which discloses a high gain visual system with a wide viewing angle.

### DISCLOSURE

### Technical Problem

An object of the present invention is to provide a 3D-enabled high-brightness metal screen device capable of focusing light of an image irradiated from a projector onto a viewable section, and realizing a bright screen having high brightness with low power consumption.

### Technical Solution

The 3D high-brightness metal screen device according to the present invention refers to a 3D high-brightness metal screen device for scattering and reflecting image light incident from a projector at a set angle and only toward a front viewable section, and includes: a reflective panel portion formed of a metallic material with optical characteristics of scattering and reflecting to have a panel shape, and having a front surface formed as a spherical surface recessed rearward and a rear surface formed as a spherical surface protruding rearward; and a plurality of metal crystal protruding/recessed portions which protrude at the front surface of the reflective panel portion so as to have a set surface roughness (Ra), and which scatter and reflect light emitted from the projector at a set angle and toward the set viewable section, wherein the reflective panel portion adjusts a viewing distance of the viewable section and vertical and lateral widths and brightness of the viewable section by adjusting a surface roughness (Ra) of the metal crystal protruding/recessed portions.

In addition, the projector may be positioned at a point of curvature radius (R) defined by the front surface of the reflective panel portion, and the curvature radius (R) of the reflective panel portion may be adjusted, so that a viewing distance of the viewable section, vertical and lateral widths of the viewable section and brightness are changed.

In addition, the device according to the present invention may further include an adjusting portion connected to the rear surface of the reflective panel portion to change a forward/rearward position and a scattering reflection angle of the reflective panel portion.

In addition, the adjusting portion may further include: a first horizontal support fixed to a structure and formed therein with a first guide groove having a length extending in forward/rearward directions and opened forward; a second horizontal support having a rear end slidably inserted into the first guide groove and a front end protruding forward from the first horizontal support; a hinge portion provided at the front end of the second horizontal support to form a horizontal rotation center in left and right directions and rotatably connected to the rear surface of the reflective panel portion; a length-adjusting screw rotatable about a horizontal rotation center formed in the forward/rearward directions of the first guide groove, and having a front end connected to the rear end of the second horizontal support in a screw-coupling manner; a length-adjusting motor connected to the first horizontal support and having a drive shaft protruding to one side and mechanically connected to the rear end of the length-adjusting screw to transmit rotational force; an angle-adjusting motor coupled to one side of the hinge portion and having a drive shaft protruding to one side to transmit rotational force to the horizontal rotation center of the hinge portion; and a control unit for controlling operations of the length-adjusting motor and the angle-adjusting motor.

### Advantageous Effects

According to the present invention, the scattering reflection properties of 1.5×¹⁰^{⁴}/mm² metal crystals per unit area are used, so that among ambient light, ambient light on the right is sent to the left and ambient light of the ceiling is sent to the floor. In other words, only image light of the projector is sent to the viewable section to minimize the ambient light in the viewable section, and the image light of the projector is scattered and reflected only in the viewable section without being sent upward, downward, leftward, and rightward (non-viewing areas) to increase brightness by 10 to 20 times. Accordingly, daytime viewing can be provided even without using a highly bright projector, a bright screen (1000 nits or higher) of a large screen (150~300 inches) can be provided, and the metallic reflective panel portion is used so that a passive 3D can be provided In other words, a large screen (150~300 inches), high brightness (1000 nit or higher), passive 3D, low power-consuming, and low cost projector screen can be implemented.

### DESCRIPTION OF DRAWINGS

FIG. 1 is a perspective view showing a 3D high-brightness metal screen device according to the present invention.

FIG. 2 is a sectional side view showing the 3D high-brightness metal screen device according to the present invention.

FIG. 3 is a sectional plan view showing the 3D high-brightness metal screen device according to the present invention.

FIG. 4 is a sectional side view showing a process in which light from a projector is reflected and diffused in the 3D high-brightness metal screen device according to the present invention.

FIG. 5 is a perspective view showing a state in which a position of a viewable section changes by adjusting surface roughness in the 3D high-brightness metal screen device according to the present invention.

FIG. 6 is a sectional plan view showing a state in which a diffusion angle changes by adjusting surface roughness in the 3D high-brightness metal screen device according to the present invention.

FIG. 7 is a sectional side view showing an adjusting portion of the 3D high-brightness metal screen device according to the present invention.

FIG. 8 is a sectional side view showing a process of adjusting an angle of a reflective panel portion in the 3D high-brightness metal screen device according to the present invention.

### BEST MODE

Hereinafter, preferred embodiments of the present invention will be described in detail with reference to the accompanying drawings.

Advantages and features of the present invention, and methods for achieving the advantages and features will be apparent with reference to the embodiments described below in detail with the accompanying drawings.

However, the present invention is not limited to the embodiments disclosed as below and may be implemented in various different forms. The embodiments are provided to complete the disclosure of the present invention and clearly teach the scope of the invention to a person having ordinary skill in the art, and the present invention will be defined only by the scope of claims.

Further, when it is determined that a detailed description of the related known technology may unnecessarily make the subject matter of the present invention unclear in the following description of the present invention, the detailed description will be omitted.

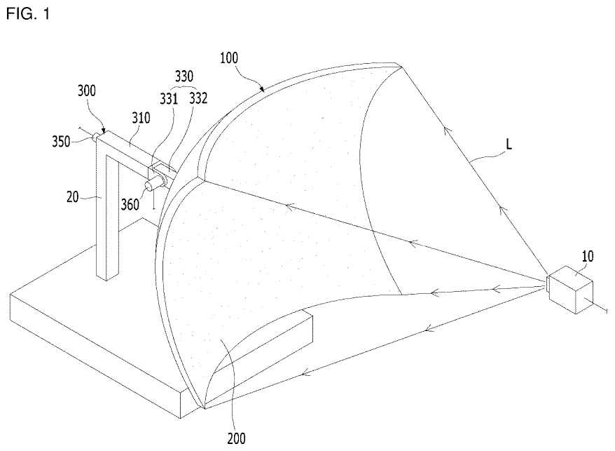

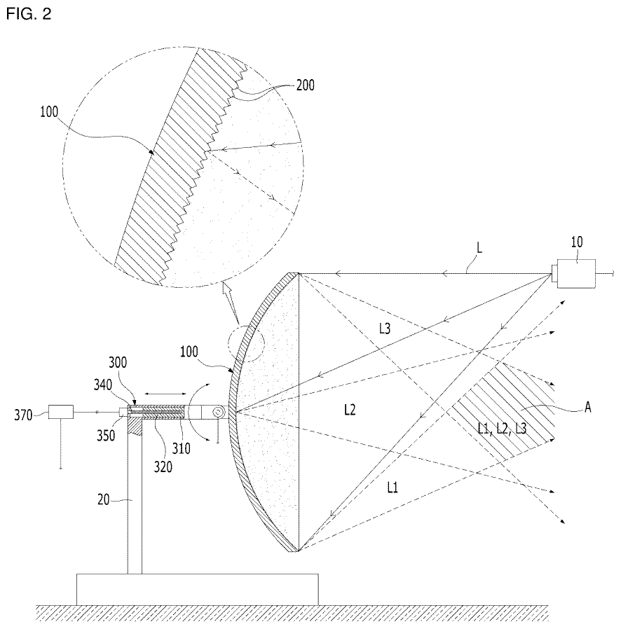

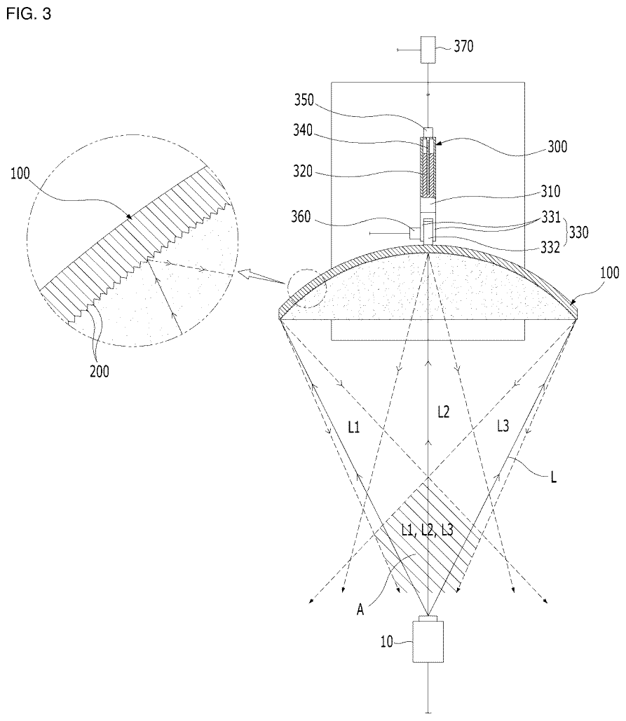

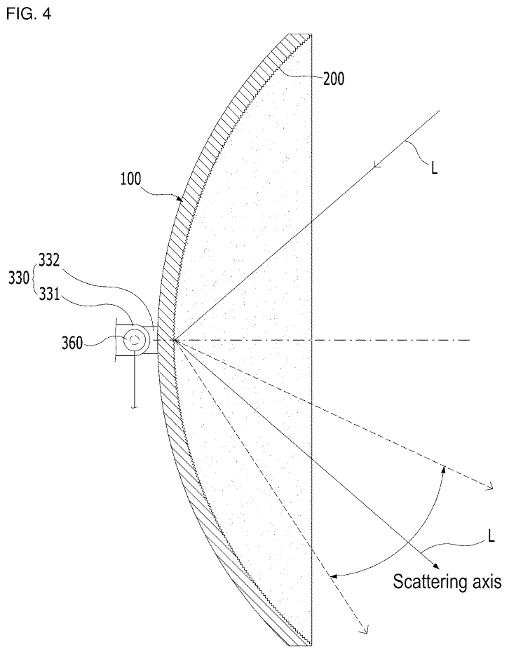

FIG. 1 is a perspective view showing a 3D high-brightness metal screen device according to the present invention; FIG. 2 is a sectional side view showing the 3D high-brightness metal screen device according to the present invention; FIG. 3 is a sectional plan view showing the 3D high-brightness metal screen device according to the present invention; and FIG. 4 is a sectional side view showing a process in which light from a projector is reflected and diffused in the 3D high-brightness metal screen device according to the present invention.

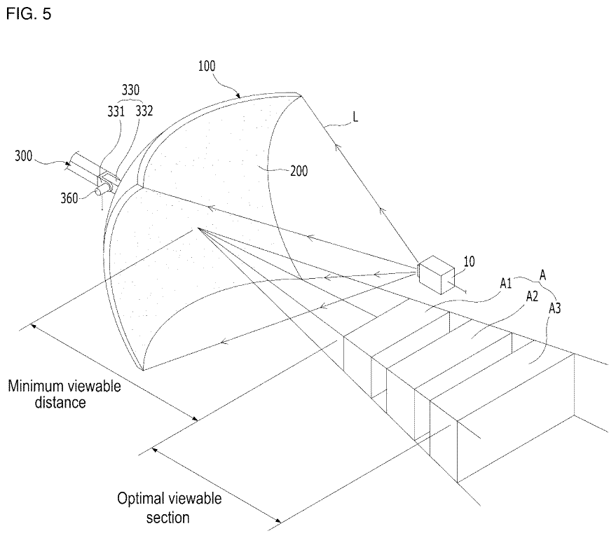

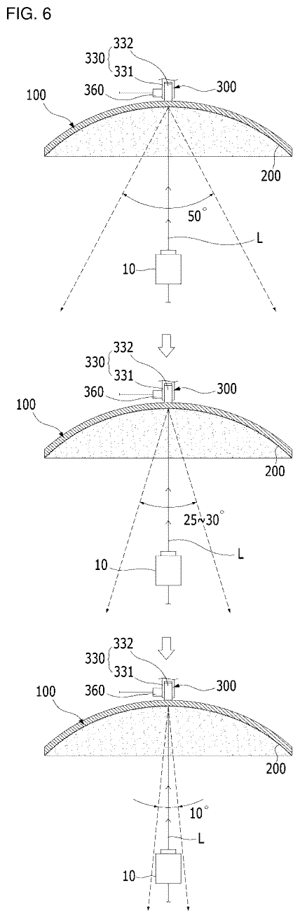

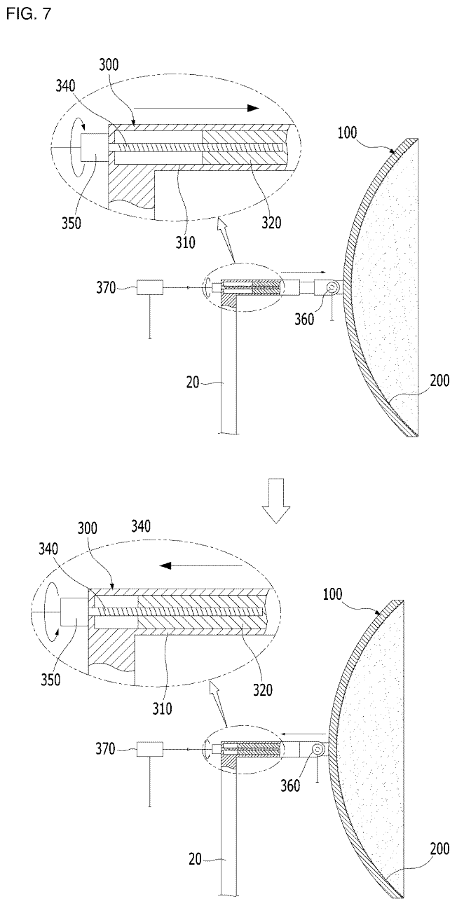

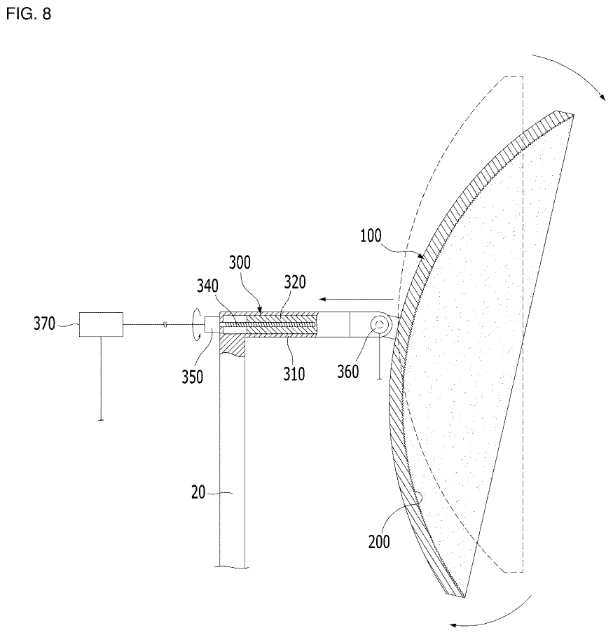

FIG. 5 is a perspective view showing a state in which a position of a viewable section changes by adjusting surface roughness in the 3D high-brightness metal screen device according to the present invention; FIG. 6 is a sectional plan view showing a state in which a diffusion angle changes by adjusting surface roughness in the 3D high-brightness metal screen device according to the present invention; FIG. 7 is a sectional side view showing an adjusting portion of the 3D high-brightness metal screen device according to the present invention; and FIG. 8 is a sectional side view showing a process of adjusting an angle of a reflective panel portion in the 3D high-brightness metal screen device according to the present invention.

Referring to FIGS. 1 and 2, the 3D high-brightness metal screen device according to the present invention is a 3D high-brightness metal screen device for scattering and reflecting light L of an image incident from a projector 10 to a forward viewable section A, and includes a reflective panel portion 100 and a plurality of metal crystal protruding/recessed portions 200.

The reflective panel portion 100 is configured to scatter and reflect the light L of the image incident from the projector 10 to the forward viewable section A, and may be installed vertically to have a front surface facing the viewing area, may be manufactured to have a metal thin plate shape using a metal material, such as aluminum (Al), gold (Au), silver (Ag), or copper (Cu), having a face-centered cubic lattice (Fcc) crystal structure to form the metal crystal protruding/recessed portions 200 described later on the front surface, and may have a rectangular panel shape with four sides formed along edges thereof.

The reflective panel portion 100 may have a front surface forming a spherical surface concave rearward and a rear surface forming a spherical surface convex rearward, and a screen size (150 to 500 inches, etc.) and a front-rear thickness (10 to 15 μm, etc.) of the reflective panel portion 100 may be applied in various manners as needed. The viewable section A refers to a section in which light L scattered and reflected by the front surface of the reflective panel portion 100 and spreads at a set angle (15 to 40 degrees, etc.) intersects. When a viewer looks at the front surface of the reflective panel portion 100 within the viewable section A, the light L of the scattered reflected image may be focused in a direction of the viewer's gaze.

In addition, the projector 10 may be positioned at a point of curvature radius (R) defined by the front surface of the reflective panel portion 100, and the curvature radius (R) of the reflective panel portion 100 may be adjusted, so that a viewing distance of the viewable section, vertical and lateral widths of the viewable section and brightness are changed.

The optical structure of the reflective panel portion 100 is required to evenly scatter and reflect all image light having 8 million pixels (3840×2160) based on 4K, that is, 24 million sub-pixels (=8 million×3; R.G.B), into the viewable section A. As shown in FIG. 4, in order to transmit the image light of the projector 10 to the viewable section, a scattered and reflected scattering axis is required to be focused at a minimum possible distance.

As shown FIGS. 2 and 3, when image light of L1, L2 and L3 is scattered and reflected toward the viewable section A, a region of L1, L2, and L3 overlap with each other may be formed, and pixels of L1, L2, and L3 may be all viewed in the viewable section A in which L1, L2 and L3 overlap.

For example, in the case of indoor and daytime conditions of 500 lux or more in a normal screen (1 to 2 gain), brightness of the reflected image from the projector 10 becomes similar to brightness of diffusely reflected light source from the reflection panel portion 100 due to the ambient light source, and the contrast ratio and saturation of the reflected image are significantly lowered, resulting in a significant deterioration in image quality. The ambient light diffusely scattered from the reflective panel portion 100 is required to be prevented from being reflected into the viewer's viewable section A. In other words, optimal image quality may be provided by increasing hue-saturation-brightness (H.S.B) and the contrast ratio.

In addition, the 3D high-brightness metal screen device according to the present invention utilizes the optical properties of a face-centered cubic (Fcc) crystal with a dispersion scattering effect, to scatter and reflect the image light of the projector 10 only to the viewer's viewable section without transmitting the light to a section beyond the viewable section, so that the utilization efficiency of the image light can be increased by 20 to 30 times.

The metal crystal protruding/recessed portions 200 is configured to scatter and reflect the light L emitted from the projector 10 and spread the scattered and reflected light toward the viewable section A at a set angle (15 to 25 degrees, etc.), and is formed over the entire section of the reflective panel portion 100 to protrude from the front surface of the reflective panel portion 100 to have a set surface roughness (Ra). A protruding end of the metal crystal protruding/recessed portions 200 may have a set curvature, the minimum viewing distance and the screen brightness may be adjusted by adjusting the curvature of the metal crystal protruding/recessed portions 200, and the surface roughness (Ra) of the metal crystal protruding/recessed portions 200 may be adjusted to adjust a dispersion scattering angle, thereby adjusting the width of the viewable section and the screen brightness.

The metal crystal protruding/recessed portions 200 may be formed on the front surface of the reflective panel portion 100 by a rolling scheme, and a rolling process may performed in front and rear directions of the reflective panel portion 100 by using a roller of rolling equipment (not shown) so as to form the metal crystal protruding/recessed portions 200 on the front surface of the reflective panel portion 100.

In addition, a speed at which the reflective panel portion 100 is rolled and moved, a diameter of the roller, a rotation speed of the roller, an applied pressure, and the like may be adjusted, so that the surface roughness (Ra) of the metal crystal protruding/recessed portions 200 may be variously adjusted, and the angle at which the light L is scattered and reflected may be variously adjusted through the adjustment of the surface roughness of the metal crystal protruding/recessed portions 200. In other words, a scattering reflection angle is changed by the surface roughness (Ra) of the metal crystal protruding/recessed portions 200, so that the minimum viewing distance of the viewable section A, the vertical and lateral widths of the viewable section A, and the brightness of the light scattered and reflected into the viewable section may be adjusted. The scattering angle and the brightness opposite to the viewable section are inversely proportional to the square.

For example, as shown in FIGS. 5 and 6, the viewing distance may be adjusted by adjusting the surface roughness (Ra) of the metal crystal protruding/recessed portions 200, and the viewing distance may become closer from the metal crystal protruding/recessed portions 200 when the surface roughness (Ra) of the metal crystal protruding/recessed portions 200 increases. In other words, as shown FIGS. 2 and 3, the part in which the image light L overlaps may become the viewable section A, and the minimum viewable distance of the viewable section A may be adjusted depending on the surface roughness (Ra) of the metal crystal protruding/recessed portions 200. Since the image light is focused on the viewable section A, the brightness may increases by 20 times or more.

In addition, as shown in FIG. 6, when the dispersion scattering angle is 50 degrees, the screen brightness is significantly reduced, so it is not suitable for bright surroundings (500 lux or more), when the dispersion scattering angle is 25 to 30 degrees, it can be viewed in bright places (500 lux or more) and outdoors, and when the dispersion scattering angle is less than 10 degrees, it may be possible to view a very large screen (such as 2000 inches) from a distance of 50 m or more, but it is unsuitable for indoor use. In other words, when the dispersion scattering angle is 25 to 30 degrees, it is very effective for high-brightness images in 3D environments.

The reflective screen for a projector according to one embodiment of the present invention may further include an adjusting portion 300 connected to the rear surface of the reflective panel portion 100 to change a forward/rearward position and a scattering reflection angle of the reflective panel portion 100.

The adjusting portion 300 may further include: a first horizontal support 310 fixed to a structure and formed therein with a first guide groove 311 having a length extending in forward/rearward directions and opened forward; a second horizontal 320 support having a rear end slidably inserted into the first guide groove 311 and a front end protruding forward from the first horizontal support 310; a hinge portion 320 provided at the front end of the second horizontal support 320 to form a horizontal rotation center in left and right directions and rotatably connected to the rear surface of the reflective panel portion 100; a length-adjusting screw 340 rotatable about a horizontal rotation center formed in the forward/rearward directions of the first guide groove 311, and having a front end connected to the rear end of the second horizontal support 320 in a screw-coupling manner; a length-adjusting motor 350 connected to the first horizontal support 310 and having a drive shaft protruding to one side and mechanically connected to the rear end of the length-adjusting screw 340 to transmit rotational force; an angle-adjusting motor 360 coupled to one side of the hinge portion 330 and having a drive shaft protruding to one side to transmit rotational force to the horizontal rotation center of the hinge portion 330; and a control unit 370 for controlling operations of the length-adjusting motor 350 and the angle-adjusting motor 360.

The second horizontal support 320 may have the rear end slidably inserted back and forth into the first guide groove 311, a fastening groove may be concavely formed at the rear end of the second horizontal support 320 to correspond to the front end of the length-adjusting screw 340 to be inserted, and the fastening groove may have a length in the forward and backward directions. The length-adjusting screw 340 may have a thread formed on an outer circumferential surface thereof to correspond to a thread of an inner circumferential surface of the fastening groove, the thread formed on the outer circumferential surface of the length-adjusting screw 340 may be formed continuously along an axial direction while forming a spiral along the rotational direction, and the rear end of the length-adjusting screw 340 may be rotatably coupled to the rear end of the first guide groove 311.

In addition, the rear end of the length-adjusting screw 340 may pass through the first horizontal support 310 rearward, the front end of the length-adjusting motor 350 may be coupled to the rear end of the first horizontal support 310, and the drive shaft protruding forward of the length-adjusting motor 350 may be mechanically connected to the rear end of the length-adjusting screw 340 to transmit rotational power.

For example, when the length-adjusting screw 340 is rotated in the forward direction, the second horizontal support 320 may be moved forward, when the length-adjusting screw 340 is rotated in the reverse direction, the second horizontal support 320 may be retracted, and when the rotation of the length-adjusting screw 340 is stopped, the second horizontal support 320 may be fixed in the adjusted position. In other words, since the second horizontal support 320 and the reflective panel portion 100 are moved together, the reflective panel portion 100 may be positioned at a position desired by user.

The hinge portion 330 may include a first hinge 331 protruding from the front end of the second horizontal support 320, a second hinge 332 intersected and coming into close contact with one axial side of the first hinge 331 and having a front end coupled to the rear surface of the reflective panel portion 100, and a rotation shaft forming horizontal rotation centers of the first hinge 331 and the second hinge 332.

The angle-adjusting motor 360 has the front end coupled to the one axial side of the first hinge 331 opposite to the second hinge 332 so as to be driven and controlled by the control unit 370, and the drive shaft of the angle-adjusting motor 360 may be mechanically connected to one axial side of the rotation shaft by passing through the first hinge 331 in the axial direction.

For example, when the drive shaft of the angle-adjusting motor 360 is rotated in the forward direction, the reflective panel portion 100 may be rotated forward (within 30 degrees), when the drive shaft of the angle-adjusting motor 360 is rotated in the reverse direction, the reflective panel portion 100 may be rotated rearward, and when the rotation of the drive shaft is stopped, the reflective panel portion 100 may be positioned at the adjusted angle.

In other words, the angle at which the front surface of the reflective panel portion 100 faces may be variably adjusted, so that the projector 10 may be positioned at various angles on the up, down, left, or right side forward of the reflective panel portion 100, and the front surface of the reflective panel portion 100 may transmit the image light in the direction where the user is located.

As a result, according to the existing screens, it is impossible to view images due to the screen's own reflection from ambient light (especially side light) in a region having bright lightings or outdoors. According to the present invention, the side light is sent to the side (non-viewing position) other than the viewer (forward) to increase the brightness (luminance) and increase the contrast ratio, so that the image viewing is possible in brightly lit environments and bright outdoor environments.

In addition, the present invention is a technology that disperses and reflects image light projected onto the reflective panel portion 100 formed of a metal material only toward the viewer in the viewable section A capable of viewing images, without sending the image light to the side, ceiling, or floor part, that is, the non-viewable section. Thus, images having 20 to 30 times higher brightness and contrast ratio can be viewed, and energy consumption can also be reduced by one-twentieth level.

In addition, since the metal crystal structure of the reflective panel portion 100 having the surface roughness (Ra) and generating the scattered reflection is 1.5×¹⁰^{⁴}/mm² or more per unit area, light scattered in a metal crystal structure may be scattered and reflected by the Gaussian effect, and 150 inches and 4k (8 million pixels) of the reflective panel portion 100 may have 8 million×3 (R.G.B), that is, 24 million unit pixels on the screen. The area of one unit pixel is approximately 0.12 mm², and 1,000 or more metal crystals may be present in 0.12 mm². These 1,000 or more metal crystals may scatter and reflect the light from each pixel to send the light to the viewable section at a predetermined angle, light from the entire 24 million pixels may be sent to the viewable section, and accordingly, images with high definition 4K can be viewed. The scattered and reflected light may be reflected from the metal surface, to send the light incident from the projector into the viewable section without changing the polarized properties, so that the passive 3D can be implemented.

Further, the high brightness, ultra-large screen (150-200 inches, etc.), and high quality images (4K, 8K, etc.) are required to be all be satisfied, such that the viewer may significantly feel a sense of reality, which allows the viewer to feel a cognitive illusion of being close to or identical with reality in a virtual space in an environment mediated by the screen. This may allow the viewer to feel the most similar reality and easily remember and convey the message of content with a strong impression. The purpose of the invention is to manufacture a screen that satisfies all of these requirements at low cost and with good energy efficiency. Thus, the High-brightness passive 3D can be realized by the scattering reflection function of the metallic surface.

The specific embodiments of the 3D high-brightness metal screen device according to the present invention have been described. However, it is apparent that various modifications may be made without departing from the scope of the present invention. Therefore, the scope of the present invention will not be limited to the aforementioned embodiments, and will be determined by all deformations or modifications derived from the following claims and the equivalent thereof.

In other words, the above described embodiments will be understood in all respects as illustrative and not restrictive, the scope of the invention is indicated by the following claims rather than the above detailed descriptions, and all deformations or modifications derived from the idea and scope of the claims and their equivalents will be construed as being included in the scope of the present invention.

### BEST MODE FOR EMBODIMENT OF THE PRESENT INVENTION

### Mode for Invention

The Mode for Invention has been described together with the Best Mode as above.

### Industrial Applicability

The present invention may have the industrial applicability because light of an image irradiated from a projector may be focused onto a viewable section, and a bright screen having high brightness may be realized with low power consumption.

1. A reflective screen for a projector serving as a 3D high-brightness metal screen device for scattering and reflecting image light incident from a projector at a set angle and only toward a front viewable section, the reflective screen comprising:
a reflective panel portion formed of a metallic material with optical characteristics of scattering and reflecting to have a panel shape, and having a front surface formed as a spherical surface recessed rearward and a rear surface formed as a spherical surface protruding rearward; and
a plurality of metal crystal protruding/recessed portions which protrude at the front surface of the reflective panel portion so as to have a set surface roughness (Ra), and which scatter and reflect light emitted from the projector at a set angle and toward the set viewable section, wherein
the reflective panel portion adjusts a viewing distance of the viewable section and vertical and lateral widths and brightness of the viewable section by adjusting a surface roughness (Ra) of the metal crystal protruding/recessed portions.

2. The reflective screen of claim 1, wherein the projector is positioned at a point of curvature radius (R) defined by the front surface of the reflective panel portion, and the reflective panel portion is adjusted in the curvature radius (R), so that a viewing distance of the viewable section, vertical and lateral widths of the viewable section and brightness are changed.

3. The reflective screen of claim 1, further comprising:
an adjusting portion connected to the rear surface of the reflective panel portion to change a forward/rearward position and a reflection angle of the reflective panel portion.

4. The reflective screen of claim 3, wherein the adjusting portion includes:
a first horizontal support fixed to a structure and formed therein with a first guide groove having a length extending in forward/rearward directions and opened forward;
a second horizontal support having a rear end slidably inserted into the first guide groove and a front end protruding forward from the first horizontal support;
a hinge portion provided at the front end of the second horizontal support to form a horizontal rotation center in left and right directions and rotatably connected to the rear surface of the reflective panel portion;
a length-adjusting screw rotatable about a horizontal rotation center formed in the forward/rearward directions of the first guide groove, and having a front end connected to the rear end of the second horizontal support in a screw-coupling manner;
a length-adjusting motor connected to the first horizontal support and having a drive shaft protruding to one side and mechanically connected to the rear end of the length-adjusting screw to transmit rotational force;
an angle-adjusting motor coupled to one side of the hinge portion and having a drive shaft protruding to one side to transmit rotational force to the horizontal rotation center of the hinge portion; and
a control unit for controlling operations of the length-adjusting motor and the angle-adjusting motor.
